(19) United States
(12) Patent Application Publication
(10) Pub. No.: US 2026/0294056 A1
(43) Pub. Date: Oct. 1, 2026

(54) Pet Activity Travel Pack Device

(71) Applicant: Nofal Paulus, West Bloomfield, MI (US)

(72) Inventor: Nofal Paulus, West Bloomfield, MI (US)

(21) Appl. No.: 19/091,212

(22) Filed: Mar. 26, 2025

(51) Int. Cl. A45C 3/00; A01K 15/02

(52) U.S. Cl. CPC A45C 3/00; A01K 15/025; A45C 2003/007

(57) ABSTRACT

A pet activity travel pack device includes a bag having a bottom wall, a top wall, and a peripheral wall extending between the bottom wall and the top wall to define an interior space. A slit defines an opening positioned in the top wall of the bag. The slit forms a flap in the top wall. A closure is selectively engageable for securing the flap in a closed position. Each of a pair of handles is coupled to the bag. A launcher net is coupled to the bag along a longitudinal face of the bag defining a launcher storage compartment having an open end. A ball launcher is insertable into the open end of the launcher storage compartment. A plurality of balls is positionable in the interior space of the bag.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to travel pack devices and more particularly pertains to a new travel pack device for facilitating carrying and transporting implements for exercising a pet.

### (2) Description of Related Art including Information Disclosed Under 37 CFR 1.97 and 1.98

The prior art relates to travel pack devices. Known pack devices are not configured for efficient storage and transport of implements for exercising a pet such as a ball thrower, balls, and other items.

### (h) BRIEF SUMMARY OF THE INVENTION

An embodiment of the disclosure meets the needs presented above by generally comprising a bag having a bottom wall, a top wall, and a peripheral wall extending between the bottom wall and the top wall to define an interior space. A slit defines an opening positioned in the top wall of the bag. The slit forms a flap in the top wall. A closure is selectively engageable for securing the flap in a closed position. Each of a pair of handles is coupled to the bag. A launcher net is coupled to the bag along a longitudinal face of the bag defining a launcher storage compartment having an open end. A ball launcher is insertable into the open end of the launcher storage compartment. A plurality of balls is positionable in the interior space of the bag.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front side perspective view of a pet activity travel pack device according to an embodiment of the disclosure.

FIG. 2 is a top rear side perspective view of an embodiment of the disclosure.

FIG. 3 is a top front side perspective view of an embodiment of the disclosure.

FIG. 4 is a side view of an embodiment of the disclosure in use.

### (j) DETAILED DESCRIPTION OF THE INVENTION

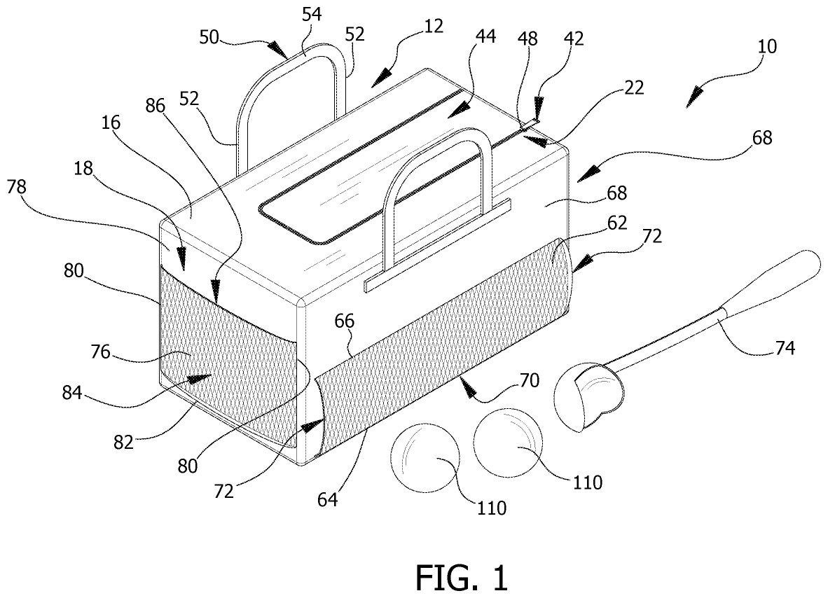

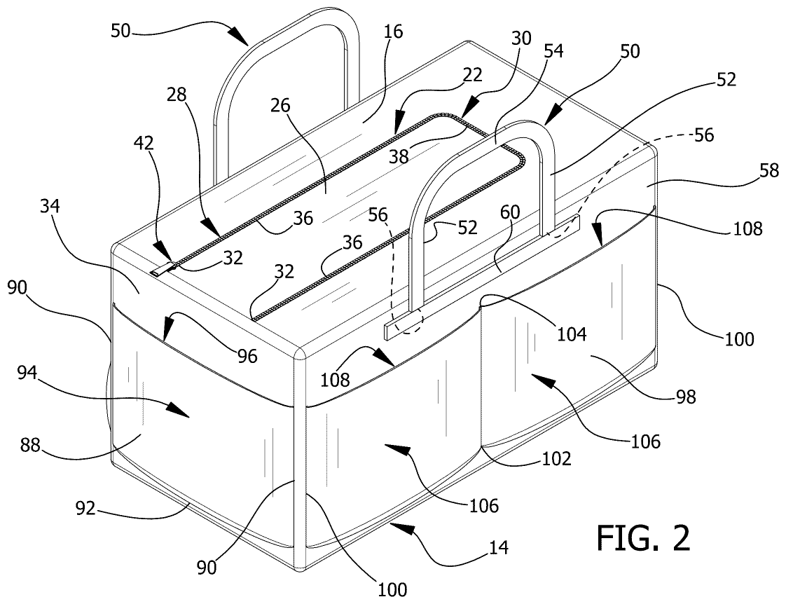

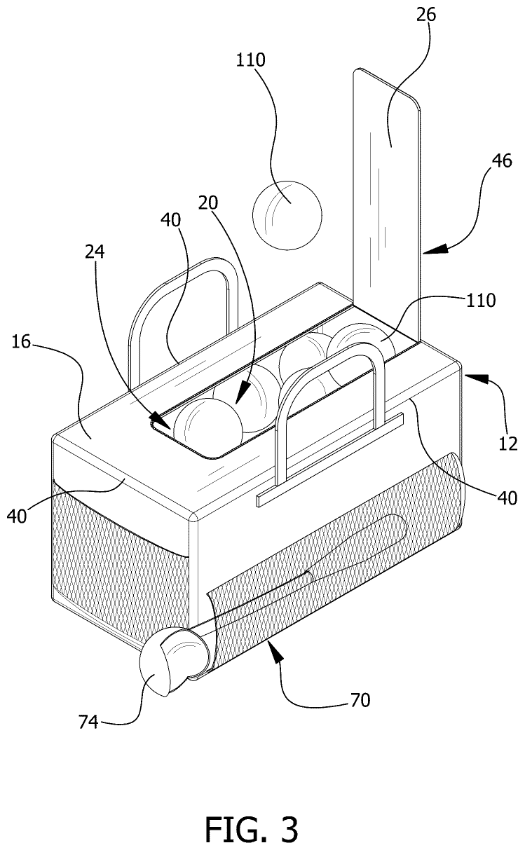

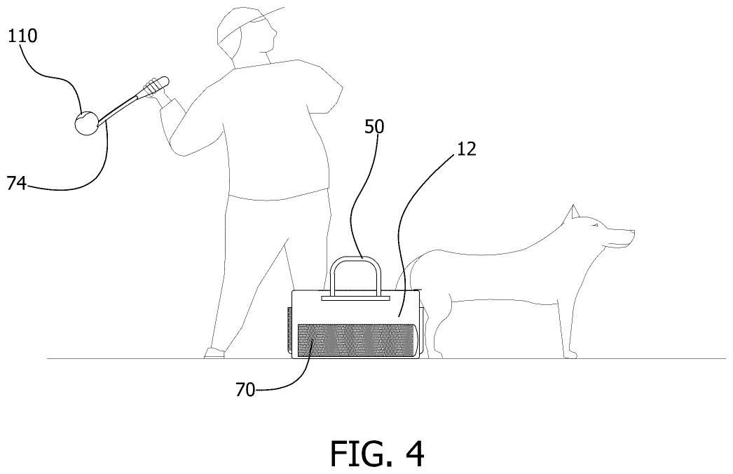

With reference now to the drawings, and in particular to FIGS. 1 through 4 thereof, a new travel pack device embodying the principles and concepts of an embodiment of the disclosure and generally designated by the reference numeral 10 will be described.

As best illustrated in FIGS. 1 through 4, the pet activity travel pack device 10 generally comprises a bag 12 having a bottom wall 14, a top wall 16, and a peripheral wall 18 extending between the bottom wall 14 and the top wall 16 to define an interior space 20. A slit 22 is in the top wall 16 defining an opening 24 positioned in the top wall 16 of the bag 12. The slit 22 forms a flap 26 in the top wall 16. The slit 22 is generally U-shaped having straight portions 28 joined by rounded corners 30. The slit 22 has opposite ends 32 aligned with a rear face 34 of the bag 12. The slit 22 has lateral sections 36 and a medial section 38 extending between the lateral sections 36. The lateral sections 36 are parallel to each other. The lateral sections 36 are inset from a peripheral edge 40 of the top wall 16. The medial section 38 is inset from the peripheral edge 40 of the top wall 16. A plurality of balls 110 is provided and can be stored in the interior space 20 of the bag 12.

A closure 42 is coupled to the flap 26 and the top wall 16. The closure 42 is selectively engageable for securing the flap 26 in a closed position 44 and allowing movement of the flap 26 into an open position 46. The closure may be a zipper 48, hook and loop fastener, or the like.

Each of a pair of handles 50 is coupled to the bag 12. Each handle 50 has lateral connection segments 52 and a grip section 54 extending between the lateral connection segments 52. Distal ends 56 of the lateral connection segments 52 are coupled to an associated lateral face 58 of the bag 12. Each of a pair of brace straps 60 is coupled to an associated lateral face 58 of the bag 12 covering the distal ends 56 of an associated pair of the lateral connection segments 52.

A launcher net 62 has a bottom edge 64 and a top edge 66 each coupled to the bag 12 along a longitudinal face 68 of the bag 12 such that the launcher netting 62 defines a launcher storage compartment 70 having an open end 72. The launcher netting 62 may be unattached from the bag 12 such that there are two open ends 72. A ball launcher 74 is provided and is insertable into the open end 72 of the launcher storage compartment 70. A front netting 76 is coupled to a front face 78 of the bag 12. The front netting 76 is coupled to the bag 12 along lateral edges 80 and a bottom edge 82 of the front netting 76 to define a front pocket 84 having an open top end 86. Similarly, a rear panel 88 is coupled to the rear face 34 of the bag 12. The rear panel 88 is coupled to the bag 12 along lateral edges 90 and a bottom edge 92 of the rear panel 88 to define a rear pocket 94 having an open top end 96. A side panel 98 is coupled to one of the lateral sides 30 of the bag 12. The side panel 98 is coupled to the bag 12 along lateral edges 100 and a bottom edge 102. The side panel 98 is also coupled to the bag 12 from the bottom edge 102 to a top edge 104 between the lateral edges 100 to define a pair of side pockets 106 each having a respective open top 108.

In use, the balls 110 and ball launcher 74 can be stored and transported in the interior space 20 of the bag 12 and the launcher storage compartment 70, respectively. The exterior position and netting of the launcher storage compartment 70 allows for easy visual confirmation the ball launcher 74 is in the launcher storage compartment 70, and allows for ventilation to get to the ball launcher 74 which may have become dirty or dampened by saliva transferred from the balls 110 during play. It is to be understood that the balls 110 can become wet with saliva and dirty with mud or the like during play. The netting of the front pocket 84 allows for ventilation when used balls 110 are placed into the front pocket 84. The netting further inhibits collection of debris or dirt within the front pocket 84. Additional items can also be stored in each of the rear pocket 94 and side pockets 106 if so desired.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

1. A pet activity travel pack device comprising:
a bag, said bag having a bottom wall, a top wall, and a peripheral wall extending between said bottom wall and said top wall to define an interior space;
a slit in said top wall defining an opening positioned in said top wall of said bag, said slit forming a flap in said top wall;
a closure coupled to said flap and said top wall, said closure being selectively engageable for securing said flap in a closed position and allowing movement of said flap into an open position;
a pair of handles coupled to said bag;
a launcher net having a bottom edge and a top edge each coupled to said bag along a longitudinal face of said bag such that said launcher netting defines a launcher storage compartment having an open end, said launcher net having a length extending along said longitudinal face of said bag longer than a length of said launcher net extending between said bottom edge and said top edge, said open end of said launcher net being positioned adjacent to an end of said longitudinal face of said bag;
a ball launcher, said ball launcher being insertable into said open end of said launcher storage compartment; and
a plurality of balls, said plurality of balls being positionable in said interior space of said bag.

2. The pet activity travel pack device of claim 1, further comprising a front netting coupled to a front face of said bag, said front netting being coupled to said bag along lateral edges and a bottom edge of said front netting to define a front pocket having an open top end.

3. The pet activity travel pack device of claim 1, further comprising a rear panel coupled to a rear face of said bag, said rear panel being coupled to said bag along lateral edges and a bottom edge of said rear panel to define a rear pocket having an open top end.

4. The pet activity travel pack device of claim 1, further comprising said closure being a zipper.

5. The pet activity travel pack device of claim 1, further comprising said slit being U-shaped.

6. The pet activity travel pack device of claim 5, further comprising said slit having opposite ends aligned with a rear face of said bag.

7. The pet activity travel pack device of claim 6, further comprising said slit having lateral sections and a medial section extending between said lateral sections, said lateral sections being parallel to each other.

8. The pet activity travel pack device of claim 7, further comprising said lateral sections being inset from a peripheral edge of said top wall.

9. The pet activity travel pack device of claim 8, further comprising said medial section being inset from said peripheral edge of said top wall.

10. The pet activity travel pack device of claim 1, further comprising each handle having lateral connection segments and a grip section extending between said lateral connection segments, distal ends of said lateral connection segments being coupled to an associated lateral face of said bag.

11. The pet activity travel pack device of claim 10, further comprising a pair of brace straps, each brace strap being coupled to the associated lateral face of said bag covering said distal ends of an associated pair of said lateral connection segments.

12. The pet activity travel pack device of claim 1, further comprising a side panel coupled a lateral face of said bag, said side panel being coupled to said bag along lateral edges and a bottom edge, said side panel being coupled to said bag from said bottom edge to said top edge between said lateral edges to define a pair of side pockets each having a respective open top.

13. A pet activity travel pack device comprising:
a bag, said bag having a bottom wall, a top wall, and a peripheral wall extending between said bottom wall and said top wall to define an interior space;
a slit in said top wall defining an opening positioned in said top wall of said bag, said slit forming a flap in said top wall, said slit being U-shaped, said slit having opposite ends aligned with a rear face of said bag, said slit having lateral sections and a medial section extending between said lateral sections, said lateral sections being parallel to each other, said lateral sections being inset from a peripheral edge of said top wall, said medial section being inset from said peripheral edge of said top wall;
a closure coupled to said flap and said top wall, said closure being selectively engageable for securing said flap in a closed position and allowing movement of said flap into an open position, said closure being a zipper;
a pair of handles coupled to said bag, each handle having lateral connection segments and a grip section extending between said lateral connection segments, distal ends of said lateral connection segments being coupled to an associated lateral face of said bag;
a pair of brace straps, each brace strap being coupled to the associated lateral face of said bag covering said distal ends of an associated pair of said lateral connection segments;
a launcher net having a bottom edge and a top edge each coupled to said bag along a longitudinal face of said bag such that said launcher netting defines a launcher storage compartment having an open end, said launcher net having a length extending along said longitudinal face of said bag longer than a length of said launcher net extending between said bottom edge and said top edge, said open end of said launcher net being positioned adjacent to an end of said longitudinal face of said bag;
a ball launcher, said ball launcher being insertable into said open end of said launcher storage compartment;
a front netting coupled to a front face of said bag, said front netting being coupled to said bag along lateral edges and a bottom edge of said front netting to define a front pocket having an open top end;
a rear panel coupled to a rear face of said bag, said rear panel being coupled to said bag along lateral edges and a bottom edge of said rear panel to define a rear pocket having an open top end;
a side panel coupled one of the lateral faces of said bag, said side panel being coupled to said bag along lateral edges and a bottom edge, said side panel being coupled to said bag from said bottom edge to said top edge between said lateral edges to define a pair of side pockets each having a respective open top; and
a plurality of balls, said plurality of balls being positionable in said interior space of said bag.
